(19) United States
(12) Patent Application Publication
(10) Pub. No.: US 2020/0198360 A1
(43) Pub. Date: Jun. 25, 2020

(54) LIQUID EJECTING APPARATUS AND SUPPLY SYSTEM

(71) Applicant: SEIKO EPSON CORPORATION, Tokyo (JP)

(72) Inventor: Toshiro MURAYAMA, Fujimi-Machi (JP)

(21) Appl. No.: 16/721,187

(22) Filed: Dec. 19, 2019

(30) Foreign Application Priority Data
Dec. 21, 2018 (JP) 2018239216

(51) Int. Cl. B41J 2/175

(52) U.S. Cl. CPC B41J 2/17563

(57) ABSTRACT

A liquid ejecting apparatus includes a first tank, a recording head, a supply flow path configured to feed the ink from the first tank to the recording head, a first circulation flow path configured to circulate the ink to the first tank, a first filter chamber having a first filter, and a second filter chamber having a second filter, the second filter chamber being disposed on a downstream side of the first filter chamber in the supply flow path. A branch port is disposed on an upstream side of the second filter, the first filter chamber is configured to pass the ink through the first filter along a direction of buoyancy generated in the first filter chamber, and the second filter chamber is configured to pass the ink through the second filter against a direction of buoyancy generated in the second filter chamber.

The present application is based on, and claims priority from JP Application Serial Number 2018-239216, filed Dec. 21, 2018, the disclosure of which is hereby incorporated by reference herein in its entirety.

### BACKGROUND

### 1. Technical Field

The present disclosure relates to a liquid ejecting apparatus and a supply system, and more particularly, the present disclosure relates to an ink jet recording apparatus that discharges ink as liquid and a supply system.

### 2. Related Art

Typical examples of liquid ejecting apparatuses include ink jet recording apparatuses that discharge ink. For example, JP-A-4-212864 discusses an ink jet recording apparatus including an ink tank for storing an ink, an ink jet recording head for ejecting the ink, a supply flow path for supplying the ink from the ink tank to the ink jet recording head, and a replaceable filter provided in the supply flow path to remove foreign matter in the ink.

The filter is effective in catching foreign matter but it also catches bubbles in the ink. The caught bubbles may reduce the effective area of the filter and increase filter flow path resistance, and this may cause ink pressure loss. Furthermore, the size of bubbles varies depending on pressure and other factors and the pressure loss is not constant, and thus the ink ejection performance may become unstable.

Such problems may similarly occur not only in the ink jet recording apparatuses but also in liquid ejecting apparatuses for ejecting liquid other than ink and in supply systems for supplying liquid to a device such as a liquid ejecting head having nozzles for ejecting liquid.

### SUMMARY

According to some aspects of the present disclosure, a liquid ejecting apparatus and a supply system that achieve both increased foreign matter catching performance and an increased bubble discharging performance are provided.

According to an aspect of the present disclosure, a liquid ejecting apparatus includes a liquid storage section configured to store a liquid, an ejection section configured to eject the liquid, a supply flow path configured to feed the liquid from the liquid storage section to the ejection section, a first circulation flow path branched from the supply flow path, the first circulation flow path being configured to circulate the liquid to the liquid storage section, a first filter chamber having a first filter, the first filter chamber being disposed in the supply flow path, and a second filter chamber having a second filter, the second filter chamber being disposed on a downstream side of the first filter chamber in the supply flow path. In the liquid ejecting apparatus, a branch port from the supply flow path to the first circulation flow path is disposed on an upstream side of at least the second filter, the first filter chamber is configured to pass the liquid through the first filter along a direction of buoyancy generated in the first filter chamber, and the second filter chamber is configured to pass the liquid through the second filter against a direction of buoyancy generated in the second filter chamber. According to this aspect, a pressure difference is produced from a portion on an upstream side of the second filter of the second filter chamber toward the circulation flow path. Such a pressure difference enables the bubbles in the liquid caught on the surface of the second filter to be discharged together with the liquid from the branch port to the circulation flow path. Accordingly, the bubbles on the surface of the second filter can be reduced and the decrease in the effective area in the second filter due to the bubbles can be reduced. Consequently, the liquid can be stably supplied to the ejection section on the downstream side. Furthermore, the foreign matter in the liquid is caught on the lower side of the first filter. The caught foreign matter generally has a specific gravity greater than that of the liquid, and separates from the first filter and settles on the bottom of the first filter chamber. Accordingly, the foreign matter in the liquid on the surface of the first filter can be reduced and the clogging in the first filter can be reduced. The reduced clogging of the first filter increases the lifetime of the first filter and reduces the frequency of replacing the first filter. Furthermore, less foreign matter in the ink reaches the second filter and the ejection section, which are on the downstream side of the first filter, and thus the lifetime of the second filter and the ejection section can be increased. As described above, according to this aspect, the foreign matter catching performance and the bubble discharging performance can be increased, and clogging of the first filter and the second filter can be reduced to reduce the increase in flow path resistance, enabling stable liquid supply to the ejection section. Accordingly, the ejection section can stably eject the liquid over the long term.

In this aspect, the liquid ejecting apparatus may include a second circulation flow path configured to circulate the liquid supplied to the ejection section to the liquid storage section. The circulation-type ejection section having a second circulation flow path according to this aspect can circulate the liquid without performing liquid ejection, for example, in initial ink filling or in suppressing ink thickening. In such a state in which no liquid is ejected, the growth of bubbles on a second filter or the mixing of bubbles into the ejection section can be reduced.

In this aspect, an average diameter of the first filter may be smaller than an average diameter of the second filter. According to this aspect, the first filter can more reliably catch foreign matter.

In this aspect, a flow path resistance of the second filter may be smaller than a flow path resistance of the first filter. According to this aspect, the first filter can more reliably catch foreign matter.

In this aspect, the liquid ejecting apparatus may include a filter unit having the first filter and the first filter chamber, and the filter unit may be replaceable. According to this aspect, the first filter can more reliably catch foreign matter.

In this aspect, an upstream chamber in the first filter chamber may have a bending portion configured to change the flow direction from a horizontal direction to a buoyancy direction. According to this aspect, in the upstream chamber in the first filter chamber, the liquid flow direction changes from the horizontal direction to the buoyancy direction. Then, foreign matter in the liquid settles on the bottom of the first upstream chamber due to the inertia of the foreign matter moving in the horizontal direction or the centrifugal force applied in changing the flow direction from the horizontal direction to the buoyancy direction. With such a bending portion, some foreign matter in the liquid settles before the foreign matter reaches the first filter, and thus the amount of foreign matter to be caught by the first filter can be reduced. Accordingly, clogging of the first filter can be further reduced.

In this aspect, a pressure gauge may be disposed between the first filter chamber and the second filter chamber, the pressure gauge being configured to measure a pressure of the liquid. With such a pressure gauge, whether the liquid is supplied at a predetermined pressure from the first filter chamber to the second filter chamber can be checked.

In this aspect, a regulator configured to regulate a flow rate of the liquid from the liquid storage section fed at a pressure measured by the pressure gauge may be provided. Accordingly, the liquid flow rate regulated by the regulator based on the pressure measured by the pressure gauge reduces the liquid pressure fluctuations, and thus the liquid can be stably ejected in the ejection section.

According to another aspect of the present disclosure, a supply system for supplying a liquid to an ejecting section, the supply system includes a liquid storage section configured to store a liquid, a supply flow path configured to feed the liquid from the liquid storage section to the ejection section, a first circulation flow path branched from the supply flow path, the first circulation flow path being configured to circulate the liquid to the liquid storage section, a first filter chamber having a first filter, the first filter chamber being disposed in the supply flow path, and a second filter chamber having a second filter, the second filter chamber being disposed on a downstream side of the first filter chamber in the supply flow path. In this supply system, a branch port from the supply flow path to the first circulation flow path is disposed on an upstream side of at least the second filter, the first filter chamber is configured to pass the liquid through the first filter along a direction of buoyancy generated in the first filter chamber, and the second filter chamber is configured to pass the liquid through the second filter against a direction of buoyancy generated in the second filter chamber. According to this aspect, the foreign matter catching performance and the bubble discharging performance can be increased, and clogging of the first filter and the second filter can be reduced to reduce the increase in flow path resistance, enabling stable liquid supply to the ejection section.

### BRIEF DESCRIPTION OF THE DRAWINGS

FIG. 1 is a perspective view illustrating an ink jet recording apparatus having a supply system.

FIG. 2 is a block diagram illustrating an ink jet recording apparatus having a supply system.

FIG. 3 is a cross-sectional view illustrating a recording head.

FIG. 4 is a schematic view illustrating an ink jet recording apparatus having a supply system.

FIG. 5 is a cross-sectional view illustrating a first filter chamber according to a second embodiment.

### DESCRIPTION OF EXEMPLARY EMBODIMENTS

Hereinafter, embodiments of the present disclosure will be described in detail. It is to be understood that the following description describes an aspect of the present disclosure, and any change may be made within the scope of the present disclosure. In the drawings, the same reference numerals are used to refer to the same or similar components, and the description thereof is omitted as appropriate. In the drawings, X, Y, Z show three spatial axes orthogonal to one another. In this specification, directions along these axes are defined as an X direction, a Y direction, and a Z direction, respectively, and in each drawing, the direction toward which the arrow is pointing is defined as a positive (+) direction and the opposite direction toward which the arrow is pointing is defines as a negative (−) direction. The Z direction indicates a vertical direction, the +Z direction indicates a vertically downward direction, and the −Z direction indicates a vertically upward direction.

### First Embodiment

An ink jet recording apparatus I (hereinafter, referred to as a recording apparatus I) as an example liquid ejecting apparatus and a supply system used in the recording apparatus I will be described.

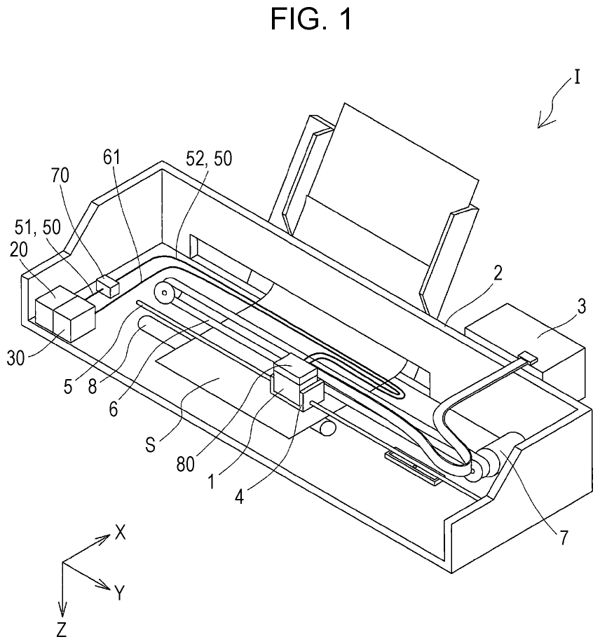

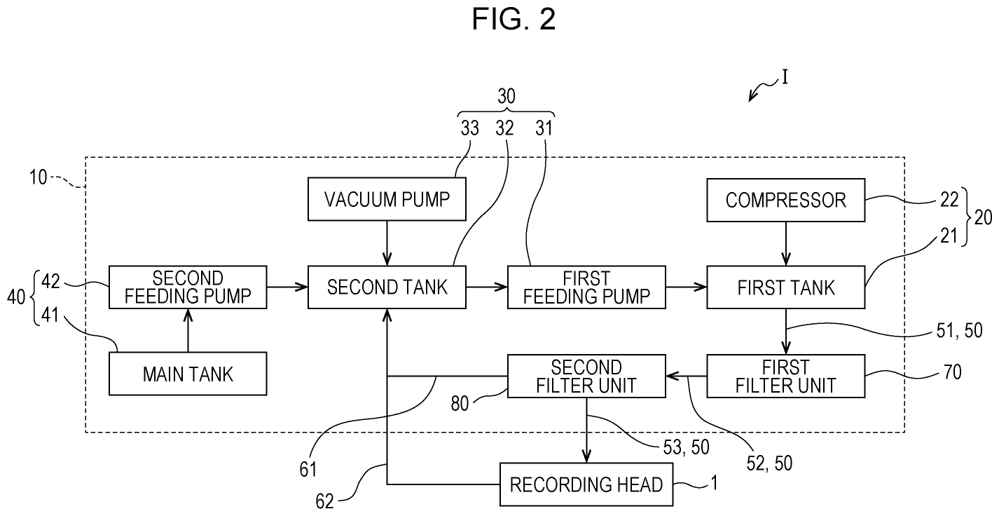

As illustrated in FIG. 1 and FIG. 2, the recording apparatus I is an apparatus that ejects an ink, which is an example liquid, and includes a recording head 1 and a supply system 10.

The recording head 1 is an example ejection section for ejecting liquid, and includes an ink supplied from the supply system 10. In this embodiment, the recording head 1 circulates an ink that was not ejected to the supply system 10. A specific structure of the recording head 1 will be described below.

The supply system 10 is a system for supplying an ink to the recording head 1. The supply system 10 includes a first supply section 20, a circulation section 30, a second supply section 40, a supply flow path 50, a first circulation flow path 61, a second circulation flow path 62, a first filter unit 70, and a second filter unit 80.

The first supply section 20 is a device that stores an ink and supplies the ink to the supply flow path 50. The first supply section 20 includes a first tank 21 and a compressor 22.

The first tank 21 is an example liquid storage section for storing an ink. The first tank 21 has a storage chamber for storing an ink, and to the first tank 21, the supply flow path 50 is connected. The compressor 22 applies pressure to the air to press walls of the storage chamber of a first tank by the air pressure. The pressure produced by the compressor 22 to the walls of the storage chamber of the first tank 21 causes the ink stored in the first tank 21 to be supplied to the supply flow path 50.

The supply flow path 50 feeds the ink from the first tank 21 to the recording head 1. The supply flow path 50 according to the embodiment includes a first tube 51, an internal flow path in the first filter unit 70, a second tube 52, an internal flow path in the second filter unit 80, and a connection flow path 53. The first tube 51 connects the first tank 21 and the first filter unit 70. The second tube 52 connects the first filter unit 70 and the second filter unit 80. The connection flow path 53 connects the second filter unit 80 and the recording head 1. The first tube 51 and the second tube 52 are flexible tubular members and disposed in the recording apparatus I. The connection flow path 53 is disposed in the second filter unit 80.

The first filter unit 70 is a device for catching foreign matter contained in an ink passing through the supply flow path 50. To the first filter unit 70, an ink is supplied from the first tank 21 via the supply flow path 50. An ink passes through a filter (not illustrated) in the first filter unit 70 where foreign matter is caught and the ink is fed to the second filter unit 80 via the supply flow path 50. The structure of the first filter unit 70 will be described in detail below.

The second filter unit 80 is a device for catching bubbles contained in an ink passing through the supply flow path 50. To the second filter unit 80, an ink is fed from the first filter unit 70 via the supply flow path 50. An ink passes through a filter (not illustrated) in the second filter unit 80 where bubbles are caught and the ink is fed to the recording head via the connection flow path 53. To the second filter unit 80, the first circulation flow path 61 is connected on an upstream side (the first filter unit 70 side) of the filter. Bubbles caught by the filter are discharged together with the ink to the first circulation flow path 61. The structure of the second filter unit 80 will be described in detail below.

The first circulation flow path 61 is branched from the supply flow path 50 and circulates an ink to the first tank 21. In this embodiment, the first circulation flow path 61 is a flexible tubular member.

The circulating an ink from the first circulation flow path 61 to the first tank 21 includes not only directly circulating an ink from the first circulation flow path 61 to the first tank 21, but also includes indirectly circulating an ink to the first tank 21 via a second tank 32 and a first feeding pump 31 as in this embodiment.

The second circulation flow path 62 circulates an ink that was not ejected by the recording head 1 to the first tank 21. In this embodiment, the second circulation flow path 62 is connected to the recording head 1 and merges with a middle portion of the first circulation flow path 61.

The circulating an ink from the second circulation flow path 62 to the first tank 21 includes not only directly circulating an ink from the second circulation flow path 62 to the first tank 21, but also includes indirectly circulating an ink from the second circulating flow path 62 to the first tank 21 via the first circulation flow path 61, the second tank 32, and the first feeding pump 31 as in this embodiment.

The circulation section 30 is a device for collecting an ink that was not ejected by the recording head 1 and an ink from the second filter unit 80, and feeds the collected ink to the first tank 21. The circulation section 30 includes the first feeding pump 31, the second tank 32, and a vacuum pump 33.

The second tank 32 is a container for storing an ink, and to the second tank 32, the first circulation flow path 61 is connected. To the second tank 32, the vacuum pump 33 is connected. By the negative pressure generated by the vacuum pump 33, an ink in the recording head 1 and an ink containing bubbles in the second filter unit 80 are collected into the second tank 32.

The second tank 32 is connected to the first tank 21 via the first feeding pump 31. The first feeding pump 31 is used to feed an ink stored in the second tank 32 to the first tank 21. By the first feeding pump 31, the ink collected into the second tank 32 is circulated to the first tank 21.

The second supply section 40 is a device for supplying an ink to the first tank 21. In this embodiment, the second supply section 40 includes a main tank 41 and a second feeding pump 42. The second supply section 40 indirectly supplies an ink to the first tank 21 via the circulation section 30. In FIG. 1, the second supply section 40 is omitted.

The main tank 41 is a container for storing an ink. The main tank 41 is connected to the second tank 32 via the second feeding pump 42. The second feeding pump 42 is used to feed an ink stored in the main tank 41 to the second tank 32. By the second feeding pump 42, the ink stored in the main tank 41 is fed to the second tank 32, and as described above, fed to the first tank 21 by the circulation section 30.

The second filter unit 80 in the above-described supply system 10 is mounted on a carriage 4 together with the recording head 1. The second filter unit 80 is detachably attached to the recording head 1. The second filter unit 80 attached to the recording head 1 enables the connection flow path 53 of the second filter unit 80 to communicate with a flow path in the recording head 1, and thereby an ink is supplied from the second filter unit 80 to the recording head 1.

In the supply system 10, the first supply section 20, the circulation section 30, the second supply section 40, the supply flow path 50, the first circulation flow path 61, the second circulation flow path 62, and the first filter unit 70 are disposed in an apparatus body 2. The first filter unit 70 is a replaceable unit. The supply flow path 50 (the first tube 51 and the second tube 52) is detachably attached to the first filter unit 70. The first filter unit 70 is detachably attached to the apparatus body 2. In replacing the first filter unit 70, the supply flow path 50 is detached from the first filter unit 70, a new first filter unit 70 is attached to the apparatus body 2 and also attached to the supply flow path 50. With this structure, when a first filter 71 is clogged with foreign matter and deteriorates, the entire first filter unit 70 can be replaced, and thus a new first filter 71 can be readily used.

It is to be understood that such a structure is merely an example, and any structure may be used. For example, the second filter unit 80 may not be mounted on the carriage 4 and may be disposed in the apparatus body 2. In such a case, the second filter unit 80 and the recording head 1 may be connected by using a tube, and the ink may be supplied through the tube.

The recording apparatus I having such a supply system 10 includes a controller 3, a moving mechanism, and a transport mechanism. The controller 3 includes, although not particularly illustrated, for example, a control device such as a central processing unit (CPU) or a field programmable gate array (FPGA), and a recording device such as a semiconductor memory. The controller 3 executes a program stored in the storage device to perform overall control of the components in the recording apparatus I.

The moving mechanism is controlled by the controller 3 to reciprocate the carriage 4 in the Y direction. The Y direction in which the carriage 4 is reciprocated by the moving mechanism intersects the X direction in which a medium S is transported. The moving mechanism according to the embodiment includes the carriage 4, a carriage shaft 5, a timing belt 6, and a drive motor 7.

The carriage shaft 5 is attached to the apparatus body 2 and the shaft direction is in line with the Y direction. The carriage 4 can be moved along the shaft direction of the carriage shaft 5. The timing belt 6 is an endless belt that is installed along the Y direction. The timing belt 6 transmits the driving force of the drive motor 7 to the carriage 4. When the drive motor 7 is driven under the control of the controller 3, the driving force of the drive motor 7 acts on the carriage 4 via the timing belt 6, and the carriage 4 reciprocates along the carriage shaft 5.

The transport mechanism is controlled by the controller 3 to transport a medium S in the X direction, and includes, for example, a transport roller 8. The transport mechanism for transporting a medium S is not limited to the transport roller 8, and may be a belt or a drum for transporting the medium S.

Such a recording apparatus I supplies an ink stored in the first tank 21 to the recording head 1. The recording head 1 ejects the ink supplied from the first tank 21 to a medium S as ink droplets, under the control of the controller 3. The ejection of the ink droplets from the recording head 1 is performed toward the positive direction of the Z direction. While the medium S is transported in the X direction by the transport mechanism and the recording head 1 is transported in the Y direction by the moving mechanism, the recording head 1 ejects ink droplets onto the medium S to form a desired image on the medium S.

The ink that has not been ejected by the recording head 1 is collected into the second tank 32, and the air that has caught by the filter in the second filter unit 80 is collected into the second tank 32 with the ink. Then, the first feeding pump 31 feeds the ink from the second tank 32 to the first tank 21 to circulate the ink.

Depending on the amount of ink consumed by the recording head 1, the second tank 32 is refilled with the ink from the main tank 41. The ink may be supplied from the main tank 41 to the second tank 32, for example, when the liquid surface of the ink in the second tank 32 becomes lower than a predetermined height.

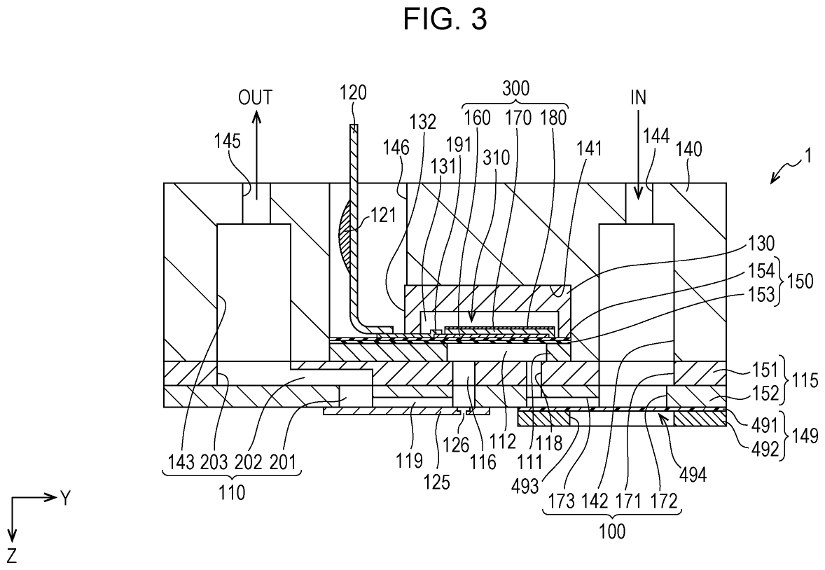

Hereinafter, with reference to FIG. 3, the recording head 1 will be described in detail. A flow path formed plate 111 in the recording head 1 is made of a metal such as stainless or nickel (Ni), a ceramic material such as ZrO₂ or AL₂O₃, a glass ceramic material, or an oxide such as MgO or LaAlO₃. In this embodiment, the flow path formed plate 111 is made of a silicon single crystal substrate. In the flow path formed plate 111, a plurality of pressure generating chambers 112 divided by a plurality of partition walls are arranged in parallel by anisotropic etching on one side. The pressure generating chambers 112 are arranged in parallel with the direction in which nozzles 126 for discharging ink are arranged in parallel. Hereinafter, this direction is referred to as a parallel arrangement direction of the pressure generating chambers 112 or the X direction. On the surface of the flow path formed plate 111, a direction that is orthogonal to the X direction is referred to as the Y direction. A direction that is orthogonal to both the X direction and the Y direction is referred to as the Z direction.

On the side of the flow path formed plate 111 opposite to a communication plate 115, a diaphragm 150 is provided. In this embodiment, the diaphragm 150 includes an elastic film 153 and an insulating film 154. The elastic film 153 is made of silicon oxide formed on the flow path formed plate 111 side. The insulating film 154 is made of zirconium oxide formed on the elastic film 153. The liquid flow paths such as the pressure generating chambers 112 are formed by anisotropic etching on the side of the flow path formed plate 111 where a nozzle plate 125 is joined, and the other side of the pressure generating chambers 112 are defined by the elastic film 153.

On the diaphragm 150 on the flow path formed plate 111, a piezoelectric actuator 300 having a first electrode 160, a piezoelectric layer 170, and a second electrode 180 is disposed. In this embodiment, the piezoelectric actuator 300 serves as a pressure generating section that varies the pressure to the ink in the pressure generating chamber 112.

The piezoelectric actuator 300 applies pressure across the first electrode 160 and the second electrode 180 to produce vibrations. The application of pressure across the first electrode 160 and the second electrode 180 produces a piezoelectric distortion in the piezoelectric layer 170 between the first electrode 160 and the second electrode 180. The portion in the piezoelectric layer 170 in which the piezoelectric distortion is produced by the application of voltage is referred to as an active portion 310. The active portion 310 is a portion of the piezoelectric layer 170 held by the first electrode 160 and the second electrode 180 in the Z direction. On the other hand, a portion in the piezoelectric layer 170 in which the piezoelectric distortion is not produced is referred to as an inactive portion. In this embodiment, the active portion 310 is provided for each pressure generating chamber 112.

The first electrode 160 is divided for each pressure generating chamber 112 and serves as an individual electrode for each active portion 310, which substantially serves as a driving portion of the piezoelectric actuator 300.

The piezoelectric layer 170 is continuously provided in the first direction X and has a predetermined width in the Y direction.

The piezoelectric layer 170 is made of a piezoelectric material such as an oxide piezoelectric material having a polarization structure and formed on the first electrode 160. For example, the piezoelectric layer 170 may be made of a perovskite oxide represented by the general formula ABO₃, or a lead-based piezoelectric material containing lead, a lead-free piezoelectric material containing no lead, or the like.

The second electrode 180 is disposed on the piezoelectric layer 170 opposite to the first electrode 160, and serves as a common electrode for a plurality of active portions 310.

From the first electrode 160 in the piezoelectric actuator 300, a discrete wiring 191, which is a lead wire, extends. From the second electrode 180, a common wiring (not illustrated), which is a lead wire, extends. To the discrete wiring 191 and the common wiring, a flexible cable 120 is connected. The flexible cable 120 is a flexible wiring board, and in this embodiment, a drive circuit 121, which is a semiconductor element, is mounted on the flexible cable 120.

To the piezoelectric actuator 300 side of the flow path formed plate 111, a protection plate 130 having substantially the same size as the flow path formed plate 111 is joined. The protection plate 130 has a space 131 that protects the piezoelectric actuator 300. The protection plate 130 has a through hole 132 that is open along the Z direction. The discrete wiring 191 from the first electrode 160 of the piezoelectric actuator 300 and an end portion of the common wiring from the second electrode 180 are exposed in the through hole 132, and are electrically connected to the flexible cable 120 in the through hole 132.

On the other side of the flow path formed plate 111 in the Z direction, the communication plate 115 and the nozzle plate 125 are stacked in sequence.

The nozzle plate 125 has a nozzle 126 for discharging ink droplets. The nozzle 126 in the nozzle plate 125 communicates with the pressure generating chamber 112 via a nozzle communication path 116 in the communication plate 115.

The communication plate 115 has an area larger than that of the flow path formed plate 111, and the nozzle plate 125 has an area smaller than that of the flow path formed plate 111. The communication plate 115 separates the nozzle 126 in the nozzle plate 125 and the pressure generating chamber 112, and thus the ink in the pressure generating chamber 112 is less affected by thickening due to evaporation of moisture in the ink around the nozzle 126. Furthermore, the nozzle plate 125 covers the opening of the nozzle communication path 116 that communicates with the pressure generating chamber 112 and the nozzle 126, and this allows the nozzle plate 125 to have a relatively small area and thus the costs can be reduced.

The communication plate 115 according to the embodiment includes a first communication plate 151 and a second communication plate 152. The first communication plate 151 and the second communication plate 152 are stacked in the Z direction such that the first communication plate 151 is on the -Z side, that is, the flow path formed plate 111 side, and the second communication plate 152 is on the +Z side, that is, the nozzle plate 125 side.

The first communication plate 151 and the second communication plate 152 may be made of a metal such as a stainless steel or nickel (Ni), ceramic such as zirconia (ZrO2), or the like. The first communication plate 151 and the second communication plate 152 may be made of the same material, that is, a material having substantially the same linear expansion coefficient. By using the same material for the first communication plate 151 and the second communication plate 152, breakage such as peeling or cracking caused by warpage due to the difference in linear expansion coefficient between the first communication plate 151 and the second communication plate 152 can be reduced.

The communication plate 115 has a first manifold section 171, a second manifold section 172, and a third manifold section 173 that communicate with a plurality of pressure generating chambers 112. The first manifold section 171, the second manifold section 172, the third manifold section 173, and a fourth manifold section 142 in a case member 140, which will be described below in detail, constitute a manifold 100 that commonly communicates with the pressure generating chambers 112.

The first manifold section 171 passes through the first communication plate 151, which is a first flow path member, in the Z direction.

The second manifold section 172 passes through the second communication plate 152, which is a second flow path member, in the Z direction.

The third manifold section 173 is open on the nozzle plate 125 side of the second communication plate 152 without passing through the second communication plate 152 in the Z direction. The third manifold section 173 communicates with the second manifold section 172 on the nozzle 126 side in the Y direction.

The communication plate 115 includes a supply communication path 118 that communicates with an end portion of the pressure generating chamber 112 in the Y direction, and the supply communication path 118 is provided for each pressure generating chamber 112. The supply communication path 118 communicates with the third manifold section 173 and the pressure generating chamber 112. More specifically, the supply communication paths 118 are disposed side by side in the first direction X with respect to the third manifold sections 173.

The communication plate 115 also has a circulation communication path 119, a first circulation manifold section 201, a second circulation manifold section 202, and a third circulation manifold section 203.

The circulation communication path 119 is open on the nozzle plate 125 side of the second communication plate 152 without passing through the second communication plate 152 in the Z direction. A plurality of circulation communication paths 119 are provided for the individual nozzle communication paths 116 where one ends of the circulation communication paths 119 communicates with the nozzle communication paths 116 respectively.

The first circulation manifold section 201 passes through the second communication plate 152 in the Z direction. The first circulation manifold section 201 commonly communicates with the circulation communication paths 119, and is disposed continuously in the first direction X in which the circulation communication paths 119 are disposed side by side. The other end of the circulation communication path 119 communicates with the nozzle 126 side of the first circulation manifold section 201 in the Y direction.

The second circulation manifold section 202 is open in the first communication plate 151 on the second communication plate 152 side without passing through the first communication plate 151 in the Z direction. The second circulation manifold section 202 is disposed on a joint surface between the first communication plate 151 and the second communication plate 152.

The third circulation manifold section 203 passes through the first communication plate 151 in the Z direction.

The first circulation manifold section 201, the second circulation manifold section 202, and the third circulation manifold section 203, which are provided in the communication plate 115, and a fourth circulation manifold section 143 in the case member 140, which will be described below in detail, constitute a circulation manifold 110.

In the recording head 1, an ink is supplied from the manifold 100 through the supply communication path 118, the pressure generating chamber 112, to the nozzle communication path 116, and the ink supplied to the nozzle communication path 116 is supplied through the circulation communication path 119 to the circulation manifold 110.

The case member 140 is fixed to the −Z side of the protection plate 130 and the communication plate 115. The case member 140 has substantially the same shape as the above-described communication plate 115 in plan view, and is joined to both the protection plate 130 and the communication plate 115. The case member 140 has a concave portion 141 of a depth enough to accommodate the flow path formed plate 111 and the protection plate 130. The concave portion 141 has an opening area wider than the area of the protection plate 130. The opening surface of the concave portion 141 on the nozzle plate 125 side is sealed by the communication plate 115 with the flow path formed plate 111 and the protection plate 130 being accommodated in the concave portion 141.

The case member 140 has, on both sides in the Y direction respectively, the fourth manifold section 142 and the fourth circulation manifold section 143 that are open on the communication plate 115 side in the Z direction.

The first manifold section 171, the second manifold section 172, and the third manifold section 173, which are provided in the communication plate 115, and the fourth manifold section 142 in the case member 140 constitute the manifold 100.

The first circulation manifold section 201, the second circulation manifold section 202, and the third circulation manifold section 203, which are provided in the communication plate 115, and the fourth circulation manifold section 143 in the case member 140 constitute the circulation manifold 110.

The case member 140 also has an inlet 144 that communicates with the manifold 100 and supplies an ink to the manifold 100, and a discharge port 145 that communicates with the circulation manifold 110 and discharges an ink from the circulation manifold 110.

A compliance plate 149 is provided on the +Z side of the communication plate 115. The compliance plate 149 seals the openings on the +Z side of the second manifold section 172 and the third manifold section 173. The compliance plate 149 according to the embodiment includes a sealing film 491 made of a flexible thin film and a fixing plate 492 made of a hard material such as metal. An area of the fixing plate 492 facing the manifold 100 is an opening 493 that is a through hole extending in the thickness direction, and thus the one side of the manifold 100 serves as a compliance section 494 that is a flexible section sealed only by the flexible sealing film 491. The compliance section 494 deforms and thereby the compliance plate 149 absorbs pressure fluctuations in the manifold 100 and the like.

The compliance plate 149 may comprise only the fixing plate 492. For example, a part of the fixing plate 492 is thinned to form the compliance section 494 for absorbing pressure fluctuations in the manifold 100 and the like.

The case member 140 also has a connection port 146 that communicates with the through hole 132 in the protection plate 130, and through which the flexible cable 120 is inserted.

To the recording head 1 of such a structure, an ink is supplied from the supply system 10 through the inlet 144, the manifold 100, and the pressure generating chamber 112 to the circulation manifold 110. The ink supplied to the circulation manifold 110 is discharged from the discharge port 145 to the supply system 10. By the operation, the ink is circulated between the supply system 10 and the recording head 1.

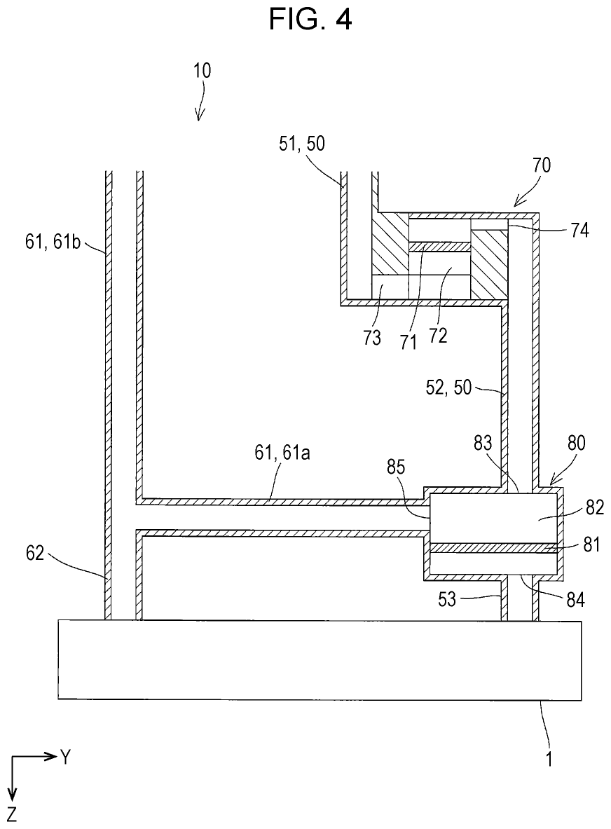

Hereinafter, with reference to FIG. 4, the first filter unit 70 and the second filter unit 80 will be described in detail. The first filter unit 70 includes a first filter chamber 72 that is a part of the supply flow path 50. The first filter chamber 72 according to the embodiment is an internal flow path inside a box-like member. The first filter chamber 72 has two openings, that is, a first inlet 73 and a first outlet 74. Between the first inlet 73 and the first outlet 74, the first filter 71 is disposed.

The first filter 71 catches foreign matter in the ink to filter the ink. For example, the first filter 71 may be a sheet-type filter having fine holes made of finely weaved or knitted fibers of a metal, resin, or the like, a plate-type filter of a metal, resin, or the like having fine through holes, or a nonwoven fabric.

The first tube 51 is connected to the first inlet 73 and the second tube 52 is connected to the first outlet 74. An ink is supplied from the supply system 10 (first tank 21) through the first tube 51 to the first inlet 73. The ink from the first inlet 73 passes through the first filter 71 and is discharged from the first outlet 74 to the second tube 52.

In the first filter chamber 72, the ink passes through the first filter 71 along a direction of buoyancy generated in the first filter chamber 72. The direction of buoyancy is a direction of buoyancy of an ink supplied to the first filter chamber 72, and in this embodiment, the direction is from the +Z side toward the −Z side in the Z direction. The expression “In the first filter chamber 72, the ink passes through the first filter 71 along a direction of buoyancy generated in the first filter chamber 72” means that the flow of ink from the lower side (+Z side) toward the upper side (−Z side) in the buoyancy direction is dominant and the first filter 71 is disposed to cross the flow.

More specifically, the first filter chamber 72, in the direction (Z direction) of buoyancy, has the first inlet 73 on the lower side and the first outlet 74 on the upper side. In the first filter chamber 72, a substantially horizontal first filter 71 is disposed between the first inlet 73 and the first outlet 74 to cross the ink flow. It is to be understood that the first filter 71 may be substantially horizontal or may be tilted with respect to the buoyancy direction.

In the first filter unit 70 having such a structure, an ink flows from the first inlet 73 toward the first outlet 74 by the action of positive pressure generated by the compressor 22 or the action of negative pressure by the vacuum pump 33. In the ink in the first filter chamber 72, the ink flow from the lower side (+Z side) toward the upper side (−Z side) in the buoyancy direction is dominant. Accordingly, the ink passes through the first filter 71 from the lower side toward the upper side. Foreign matter in the ink is caught on the lower side of the first filter 71, and the ink from which the foreign matter has been removed is supplied from the first filter unit 70 to the second filter unit 80.

The second filter unit 80 includes a second filter chamber 82 that is a part of the supply flow path 50. The second filter chamber 82 according to the embodiment is an internal flow path inside a box-like member. The second filter chamber 82 has three openings, that is, a second inlet 83, a second outlet 84, and a branch port 85. Between the second inlet 83 and the branch port 85 and the second outlet 84, the second filter 81 is disposed. In the second filter chamber 82, the second inlet 83 and the branch port 85 are disposed on an upstream side of the second filter 81 and the second outlet 84 is disposed on a downstream side of the second filter 81.

The second filter 81 catches bubbles in the ink. For example, the second filter 81 may be a sheet-type filter having fine holes made of finely weaved or knitted fibers of a metal, resin, or the like, a plate-type filter of a metal, resin, or the like having fine through holes, or a nonwoven fabric.

The branch port 85 is an opening on the second filter chamber 82 and is a branch from the supply flow path 50 to the first circulation flow path 61, and is provided on the upstream side (first filter unit 70 side) of the second filter 81. To the branch port 85, the first circulation flow path 61 is connected.

To the second inlet 83, the second tube 52 is connected, and to the second outlet 84, the connection flow path 53 is connected. An ink is supplied from the first filter unit 70 through the second tube 52 to the second inlet 83. The ink from the second inlet 83 passes through the second filter 81 and is discharged from the second outlet 84 to the connection flow path 53. The ink from the second inlet 83 is discharged from the branch port 85 to the first circulation flow path 61.

In the second filter chamber 82, the ink passes through the second filter 81 against a direction of buoyancy generated in the second filter chamber 82. The direction of buoyancy is a direction of buoyancy of an ink supplied to the second filter chamber 82, and in this embodiment, the direction is from the +Z side toward the −Z side in the Z direction. The expression “In the second filter chamber 82, the ink passes through the second filter 81 against a direction of buoyancy generated in the second filter chamber 82” means that the flow of ink from the upper side (−Z side) toward the lower side (+Z side) in the buoyancy direction is dominant and the second filter 81 is disposed to cross the flow.

The second filter chamber 82, in the direction (Z direction) of buoyancy, has the second inlet 83 on the upper side and the second outlet 84 on the lower side. In the second filter chamber 82, a substantially horizontal second filter 81 is disposed between the second inlet 83 and the second outlet 84 to cross the ink flow. It is to be understood that the second filter 81 may be substantially horizontal or may be tilted with respect to the buoyancy direction.

In the second filter unit 80 having such a structure, an ink flows from the second inlet 83 toward the second outlet 84 by the action of positive pressure generated by the compressor 22 or the action of negative pressure by the vacuum pump 33. In the second filter chamber 82, the ink flow from the upper side (−Z side) toward the lower side (+Z side) against the buoyancy direction is dominant. Accordingly, the ink passes through the second filter 81 from the upper side toward the lower side. Bubbles in the ink is caught on the upper side of the second filter 81, and the ink from which the bubbles have been removed is supplied from the second filter unit 80 to the recording head 1.

The second circulation flow path 62 connects the discharge port 145 (see FIG. 3) of the recording head 1 and a middle portion of the first circulation flow path 61. An ink discharged from the discharge port 145 of the recording head 1 is circulated through the second circulation flow path 62 and the first circulation flow path 61 toward the first tank 21.

The specific structures of the first circulation flow path 61 and the second circulation flow path 62 are not particularly limited, and for example, the following structure may be employed. The first circulation flow path 61 may include a circulation flow path portion 61a and a circulation flow path portion 61b. The circulation flow path portion 61a is a part of the second filter unit 80 and connected to the branch port 85. The second circulation flow path 62 is a part of the second filter unit 80 and connected to the discharge port 145 of the recording head 1. The second circulation flow path 62 merges with the circulation flow path portion 61a in the second filter unit 80. The circulation flow path portion 61b, which is a tubular member, is connected to the circulation flow path portion 61a. With such a structure, the ink from the branch portion 85 and the recording head 1 is circulated through the first circulation flow path 61 and the second circulation flow path 62 toward the first tank 21.

The above-described recording apparatus I according to the embodiment supplies an ink from the first tank 21 through the supply flow path 50 to the recording head 1 while circulating the ink from the supply flow path 50 through the first circulation flow path 61 to the first tank 21. In the ink circulation, the compressor 22 applies positive pressure to the supply flow path 50 and the vacuum pump 33 applies negative pressure to the first circulation flow path 61, and the supply flow path 50 side is under a relatively positive pressure.

Such a structure produces a pressure difference from the portion on the upstream side of the second filter 81 of the second filter chamber 82 toward the first circulation flow path 61. The pressure difference enables the bubbles in the ink caught by the upper side of the second filter 81 to be discharged together with the ink from the branch port 85 to the first circulation flow path 61. Accordingly, the bubbles on the surface of the second filter 81 can be reduced and the decrease in the effective area in the second filter 81 due to the bubbles can be reduced. Consequently, the ink can be stably supplied to the recording head 1 on the downstream side.

If a structure in which the supply flow path 50 is under positive pressure and the first circulation flow path 61 is omitted is employed, bubbles are caught by the second filter 81. The caught bubbles gather and cover the entire surface of the second filter 81. The bubbles are pushed by the ink and pass through the second filter 81, but unless the bubbles grow to such an extent, the bubbles remain on the second filter 81. Accordingly, without the first circulation flow path 61, the effective area in the second filter 81 is reduced due to the bubbles and the flow path resistance increases. The increased flow path resistance may hinder the stable ink supply to the recording head 1.

Furthermore, in the recording apparatus I according to the embodiment, the foreign matter in the ink is caught on the lower side of the first filter 71. The caught foreign matter generally has a specific gravity greater than that of the ink, and separates from the first filter 71 and settles on the bottom of the first filter chamber 72. Accordingly, the foreign matter in the ink on the surface of the second filter 71 can be reduced and clogging of the first filter 71 can be reduced. The reduced clogging of the first filter 71 increases the lifetime of the first filter 71 and reduces the frequency of replacing the first filter 71. Furthermore, less foreign matter in the ink reaches the second filter 81 and the recording head 1, which are on the downstream side of the first filter 71, and thus the lifetime of the second filter 81 and the recording head 1 can be increased.

In the recording apparatus I according to the embodiment, the first filter 71 catches foreign matter but passes bubbles. The second filter 81, however, catches the bubbles and the bubbles are discharged from the first circulation flow path 61. Accordingly, the mixing of bubbles into the recording head 1 can be reduced.

As described above, the supply system 10 according to the embodiment catches greater amount of foreign matter and discharges more bubbles, and thus clogging of the first filter 71 and the second filter 81 can be reduced and the increase in flow path resistance can be reduced, enabling stable ink supply to the recording head 1. Furthermore, the recording apparatus I according to the embodiment catches greater amount of foreign matter and discharges more bubbles, and thus clogging of the first filter 71 and the second filter 81 can be reduced and the increase in flow path resistance can be reduced, enabling stable ink supply to the recording head 1, and enabling the recording head 1 to stably eject the ink over the long term.

The recording apparatus I according to the embodiment includes the second circulation flow path 62 for circulating an ink from the recording head 1 to the first tank 21. Accordingly, the recording head 1 may be referred to as a circulation-type recording head for circulating an ink that was not ejected in supplied ink to the second circulation flow path 62. In such a circulation-type recording head, greater amount of foreign matter can be caught and more bubbles can be discharged similarly to the above-described case, and thus the ink can be stably ejected over the long term.

Furthermore, the recording head 1 may circulate an ink as described above even when the ink ejection from the nozzles 126 is not performed, for example, in initial ink filling or in suppressing ink thickening. In such a state in which no ink is ejected, the second filter 81 catches bubbles and the bubbles are discharged to the first circulation flow path 61. Accordingly, the growth of bubbles in the second filter 81 or the mixing of bubbles into the recording head can be reduced.

The average diameter of the first filter 71 may be smaller than the average diameter of the second filter 81. In many cases, the size of foreign matter in ink is larger than the size of bubbles in the ink. Accordingly, with the above-described average diameter, foreign matter can be more reliably caught by the first filter 71. The average diameter means an average diameter of the surface of one side or the other side of the first filter 71 or the second filter 81, and the average diameter can be measured by a known method such as mercury injection method, nitrogen adsorption method, or SEM image observation.

As described above, when the average diameter of the first filter 71 is smaller than the average diameter of the second filter 81, the flow path resistance of the second filter 81 is smaller than the flow path resistance of the first filter 71. Accordingly, the first filter 71 in such a flow path resistance relationship can also more reliably catch foreign matter.

In the recording apparatus I according to the embodiment, the first filter unit 70 having the first filter 71 and the first filter chamber 72 can be replaced. The first filter unit 70 can be separated from the recording head 1 and separately replaced. With this structure, when the first filter 71 is clogged with foreign matter and deteriorates, the entire first filter unit 70 can be replaced, and thus a new first filter 71 can be used. As described above, in the recording apparatus I according to the embodiment, the first filter 71 that is likely to be clogged can be readily replaced, and thus the excellent maintainability can be achieved. Furthermore, the first filter unit 70 can be replaced separately from the recording head 1, and thus the first filter unit 70 can be replaced regardless of the consumption state of the recording head 1.

### Second Embodiment

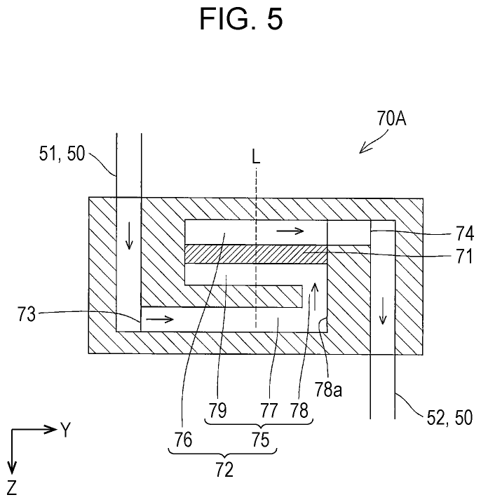

With reference to FIG. 5, a recording apparatus according to a second embodiment will be described. The recording apparatus according to the second embodiment is different from the recording apparatus I according to the first embodiment in the structure of the first filter unit 70, and the other structures are similar to those in the first embodiment. To components similar to those in the first embodiment, same reference numerals are given, and their descriptions will be omitted.

A first filter unit 70A according to the embodiment has the first filter chamber 72 having the first filter 71. In the first filter chamber 72, a portion on an upstream side (first inlet 73 side) of the first filter 71 is referred to as an upstream chamber 75, and a portion on a downstream side (first outlet 74 side) of the first filter 71 is referred to as a downstream chamber 76.

The upstream chamber 75 in the first filter chamber 72 has a bending portion 78 for changing the flow direction of an ink from a horizontal direction to a buoyancy direction (from +Z side to the −Z side). Specifically, the upstream chamber 75 has a first upstream chamber portion 77, the bending portion 78, and a second upstream chamber portion 79. The first upstream chamber portion 77 communicates with the first inlet 73 and extends in the horizontal direction. The expression “the first upstream chamber portion 77 extends in the horizontal direction” means that the first upstream chamber portion 77 extends in the horizontal direction or in a direction slightly tilted from the horizontal direction. The first upstream chamber portion 77, however, is not perpendicular to the horizontal direction, that is, not parallel to the buoyancy direction.

The second upstream chamber portion 79 faces the first filter 71. Although not particularly illustrated, the cross-sectional shape of the first upstream chamber portion 77 in an XY plane may be linear, curvilinear, circular, rectangular, or the like. The cross-sectional shape of the second upstream chamber portion 79 in the XY plane has a shape similar to that of the first filter 71.

The first upstream chamber portion 77 is connected to the bending portion 78 that extends in the buoyancy direction on a side opposite to the first inlet 73. The expression “the bending portion 78 extends in the buoyancy direction” means that the bending portion 78 is parallel to or intersect the buoyancy direction. The bending portion 78, however, is not perpendicular to the buoyancy direction, that is, not parallel to the XY plane.

In such a first filter unit 70, an ink supplied from the first tube 51 flows from the first inlet 73 through the first upstream chamber portion 77 in the horizontal direction. The ink flows into the bending portion 78 and changes the flow direction to the buoyancy direction. Then, the ink passes through the second upstream chamber portion 79 and the first filter 71 to the downstream chamber 76 and is discharged from the first outlet 74.

In the upstream chamber 75, the ink flow direction changes from the horizontal direction to the buoyancy direction. Then, foreign matter in the ink hits a side surface portion 78a of the bending portion 78 and settles on the bottom of the first upstream chamber portion 77 due to the inertia of the foreign matter moving in the horizontal direction or the centrifugal force applied in changing the flow direction from the horizontal direction to the buoyancy direction. With such a bending portion 78, some foreign matter in the ink settles before the foreign matter reaches the first filter 71, and thus the amount of foreign matter to be caught by the first filter 71 can be reduced. Accordingly, clogging of the first filter 71 can be further reduced.

Although the length of the first upstream chamber portion 77, that is, the length from the first inlet 73 to the bending portion 78 is not particularly limited, the length of the first upstream chamber portion 77 may be longer than half of the length in a first plane direction. Specifically, the first upstream chamber portion 77 may be extended from the first inlet 73 to the bending portion 78 side to be longer than a straight line L that passes a central portion of the first filter 71 in the Y direction along the Z direction. With such a first upstream chamber portion 77, the ink flow along the horizontal direction is increased, and the amount of the foreign matter that settles in the bending portion 78 can be increased.

### Third Embodiment

A recording apparatus according to a third embodiment has a structure similar to that of the recording apparatus I according to the first embodiment, however, is different from the recording apparatus I in that the recording apparatus according to the third embodiment includes a pressure gauge between the first filter chamber 72 and the second filter chamber 82, and the first supply section 20 includes a regulator.

The pressure gauge is a device for measuring a pressure of an ink flowing between the first filter chamber 72 and the second filter chamber 82. Such a pressure gauge may be disposed, for example, in the second tube 52 or at a position on the upstream side of the second filter 81 in the second filter chamber 82.

The regulator is a device for regulating the flow rate of a liquid fed from the first tank 21 based on the pressure measured by the pressure gauge. The regulator regulates the pressure of the air supplied from the compressor 22 such that the pressure of the ink measured by the pressure gauge has a predetermined pressure.

With such a pressure gauge, whether the ink is supplied at the predetermined pressure from the first filter chamber 72 to the second filter chamber 82 can be checked. Furthermore, the ink flow rate control by the regulator based on the pressure measured by the pressure gauge reduces the ink pressure fluctuations, and thus the ink can be stably ejected in the recording head 1.

### Other Embodiments

Although the embodiments of the present disclosure have been described above, the basic structures of the present disclosure are not limited to the above-described embodiments. The above-described embodiments include the first tank 21 and the second tank 32; however, the second tank 32 may be omitted and an ink may be directly circulated from the first circulation flow path 61 to the first tank 21.

The above-described embodiments use the recording head 1 in which an ink is circulated through the inlet 144, the manifold 100, the pressure generating chamber 112, the circulation manifold 110, and the discharge port 145; however, the structure of the recording head 1 is not limited to this structure. For example, in some embodiments, a circulation-type recording head having a bypass flow path connecting the manifold 100 and the circulation manifold 110 may be provided to allow an ink in the manifold 100 to flow through individual pressure generating chambers 112 and the bypass flow path to the circulation manifold 110.

Furthermore, in some embodiments, a circulation-type recording head having only the manifold 100 without the circulation manifold 110 may be provided. The manifold 100 may include the inlet 144 and the discharge port 145 to allow an ink supplied from the inlet 144 to flow through the manifold 100 to individual pressure generating chambers 112 and the discharge port 145.

Furthermore, although the above-described embodiments use the circulation-type recording head 1, a non-circulation type recording head 1 may be used. In such a case, the second circulation flow path 62 may be omitted. In some embodiments, such a non-circulation type recording head 1 may be used.

Furthermore, although the above-described embodiments include the second filter unit 80 mounted in the recording head 1, the structure is not limited to this example. For example, the second filter unit 80 and the recording head 1 may be integrated.

Furthermore, although the above-described embodiments use the recording apparatus I in which the recording head 1 is moved by the transport mechanism, that is, a so-called serial recording apparatus is used, the structure is not limited to this example. For example, in some embodiments, the recording head 1 may be fixed to the recording apparatus I and printing may be performed only by transporting a medium S, that is, a so-called line recording apparatus may be used.

The above-described embodiments have described the supply systems for supplying an ink, and the recording apparatuses for ejecting an ink as example liquid ejecting apparatuses. However, the present disclosure may be used for liquid ejecting apparatuses for ejecting a liquid other than ink, and may be applied to supply systems for supplying a liquid other than ink. For example, some embodiments of the liquid ejecting apparatuses may be applied to various liquid ejecting apparatuses, for example, image recording apparatuses such as printers, color material ejecting apparatuses to be used to manufacture color filters for liquid crystal displays or the like, electrode material ejecting apparatuses to be used to form electrodes for organic electro luminescence (EL) displays, field emission displays (FEDs), or the like, or bioorganic matter ejecting apparatuses to be used to manufacture biochips. Furthermore, the supply systems may be applied to supply a liquid to such liquid ejecting apparatuses.

What is claimed is:

1. A liquid ejecting apparatus comprising:
a liquid storage section configured to store a liquid;
an ejection section configured to eject the liquid;
a supply flow path configured to feed the liquid from the liquid storage section to the ejection section;
a first circulation flow path branched from the supply flow path, the first circulation flow path being configured to circulate the liquid to the liquid storage section;
a first filter chamber having a first filter, the first filter chamber being disposed in the supply flow path; and
a second filter chamber having a second filter, the second filter chamber being disposed on a downstream side of the first filter chamber in the supply flow path, wherein
a branch port from the supply flow path to the first circulation flow path is disposed on an upstream side of at least the second filter,
the first filter chamber is configured to pass the liquid through the first filter along a direction of buoyancy generated in the first filter chamber, and
the second filter chamber is configured to pass the liquid through the second filter against a direction of buoyancy generated in the second filter chamber.

2. The liquid ejecting apparatus according to claim 1, further comprising:
a second circulation flow path configured to circulate the liquid supplied to the ejection section to the liquid storage section.

3. The liquid ejecting apparatus according to claim 1, wherein an average diameter of the first filter is smaller than an average diameter of the second filter.

4. The liquid ejecting apparatus according to claim 1, wherein a flow path resistance of the second filter is smaller than a flow path resistance of the first filter.

5. The liquid ejecting apparatus according to claim 1, further comprising:
a filter unit having the first filter and the first filter chamber, wherein
the filter unit is replaceable.

6. The liquid ejecting apparatus according to claim 1, wherein an upstream chamber in the first filter chamber has a bending portion configured to change the flow direction from a horizontal direction to a buoyancy direction.

7. The liquid ejecting apparatus according to claim 1, further comprising:
a pressure gauge disposed between the first filter chamber and the second filter chamber, the pressure gauge being configured to measure a pressure of the liquid.

8. The liquid ejecting apparatus according to claim 7, further comprising:
a regulator configured to regulate a flow rate of the liquid from the liquid storage section sent at a pressure measured by the pressure gauge.

9. A supply system for supplying a liquid to an ejecting section, the supply system comprising:
a liquid storage section configured to store a liquid;
a supply flow path configured to feed the liquid from the liquid storage section to the ejection section;
a first circulation flow path branched from the supply flow path, the first circulation flow path being configured to circulate the liquid to the liquid storage section;
a first filter chamber having a first filter, the first filter chamber being disposed in the supply flow path; and
a second filter chamber having a second filter, the second filter chamber being disposed on a downstream side of the first filter chamber in the supply flow path, wherein
a branch port from the supply flow path to the first circulation flow path is disposed on an upstream side of at least the second filter,
the first filter chamber is configured to pass the liquid through the first filter along a direction of buoyancy generated in the first filter chamber, and
the second filter chamber is configured to pass the liquid through the second filter against a direction of buoyancy generated in the second filter chamber.
